(19) United States
(12) Patent Application Publication
(10) Pub. No.: US 2024/0310023 A1
(43) Pub. Date: Sep. 19, 2024

(54) Geode Lamp Device

(71) Applicant: Steven East, Parkville, MD (US)

(72) Inventor: Steven East, Parkville, MD (US)

(21) Appl. No.: 18/598,271

(22) Filed: Mar. 7, 2024

Related U.S. Application Data
(60) Provisional application No. 63/490,344, filed on Mar. 15, 2023.

(51) Int. Cl. F21V 3/06; F21S 9/02; F21V 23/06; F21Y 113/13; F21Y 115/10

(52) U.S. Cl. CPC F21V 3/06; F21S 9/02; F21V 23/06; F21Y 2113/13; F21Y 2115/10

(57) ABSTRACT

A geode lamp device is disclosed that is designed to illuminate geodes in a visually pleasing way. The lamp device comprises a wooden base component with a plurality of LED lights secured to it. Geodes are then secured to the wooden base component to be illuminated by the LED lights. The lamp device comprises three different color options for hue. Further, the device is dimmable depending on the needs and/or wants of a user. The lamp device is also USB compatible to allow the lamp device to function with a wide variety of socket types. Additionally, the geodes can be configured in square, oval, or circular shapes.

### CROSS-REFERENCE TO RELATED APPLICATION

The present application claims priority to, and the benefit of, U.S. Provisional Application No. 63/490,344, which was filed on Mar. 15, 2023, and is incorporated herein by reference in its entirety.

### FIELD OF THE INVENTION

The present invention relates generally to the field of geode lamp devices. More specifically, the present invention relates to an improved geode and crystal lamp with several LED lights to illuminate the crystals. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in geode lamp devices. Generally, people may enjoy using crystals and geodes for aesthetic purposes. Some may believe that different crystals offer different natural healing energies and are looking for newer and improved ways to display crystals. Further, homeopathic healing can be useful for improving mood and mental health.

Further, users may want to illuminate geodes and other crystals in a visually pleasing way but may be unsure of how to do it. Additionally, geodes and crystals of varying shapes and sizes may be difficult to illuminate and may require multiple lights for display.

Accordingly, there is a demand for an improved geode lamp device that illuminates geodes with multiple LED lights. More particularly, there is a demand for a geode lamp device that includes a USB slot to accommodate several different socket types for powering the device.

Therefore, there exists a long-felt need in the art for a geode lamp device that provides users with an improved geode and crystal lamp with several LED lights to illuminate the crystals. There is also a felt long-felt need in the art for a geode lamp device that releases enhanced healing energy through the lamp to improve homeopathic self-healing. Further, there is a long-felt need in the art for a geode lamp device that includes a USB slot to accommodate several different socket types for powering the lamp. Moreover, there is a long-felt need in the art for a device that functions as a convenient night light and lamp with a unique and decorative aesthetic. Further, there is a long-felt need in the art for a geode lamp device that is designed to illuminate geodes in a visually pleasing way. Finally, there is a long-felt need in the art for a geode lamp device that can be used with any suitable shape and size of geode.

The subject matter disclosed and claimed herein, in one embodiment thereof, comprises a geode lamp device. The device is a modified lamp designed to illuminate geodes in a visually pleasing way. The lamp device comprises a wooden base component with a plurality of LED lights secured to it. Geodes are then secured to the wooden base component to be illuminated by the LED lights. The lamp device comprises three different color options for hue. Further, the device is dimmable depending on the needs and/or wants of a user. The lamp device is also USB compatible to allow the lamp device to function with a wide variety of socket types. Additionally, the geodes can be configured in square, oval, or circular shapes. Then, depending on what crystals are used, each lamp device offers different healing properties, for example, amethyst offers calming, citrine offers joy, and quartz offers enhancing and clearing energy.

In this manner, the geode lamp device of the present invention accomplishes all of the foregoing objectives and provides users with a device that illuminates geodes and other crystals. The device is a lamp with a plurality of LEDs to illuminate geodes. The device can be utilized with any suitable geodes and crystals.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a geode lamp device. The device is a modified lamp designed to illuminate geodes in a visually pleasing way. The lamp device comprises a base component with a plurality of LED lights secured to it. Geodes are then secured to the base component to be illuminated by the LED lights. The lamp device comprises three different color options for hue. Further, the device is dimmable depending on the needs and/or wants of a user. The lamp device is also USB compatible to allow the lamp device to function with a wide variety of socket types.

Overall, a geode is typically a spherical, geological rock formation with an interior core space containing an inner lining of crystals projecting inward or layers of concentric banding. Geodes are essentially rock cavities or “vugs” with internal crystal formations or concentric banding. The plain geode exterior is generally limestone or a related rock that often reveals nothing of the beautiful, intricate display of interior crystals or banding. Other geodes are completely filled with crystal or solid throughout. These types of solid geodes are called nodules. Geodes can be found all over the world and are most commonly located in deserts, volcanic ash beds, or regions containing limestone. Further, geodes are commonly found in California, Utah, Arizona, and numerous locations in Mexico, Brazil, and Namibia.

Generally, geodes can be cut open to reveal the crystals in the core of the geode. Quartz is the most common mineral forming crystals within geodes. Still, geode cores contain agate, chalcedony, or jasper banding or crystals such as calcite, dolomite, celestite, etc. The color of the crystals depends on the type of contaminant that entered the geode when it was forming. Samples of geodes with unusual colors or highly unlikely formations are either synthetically dyed or altered with artificial colorants or pigments.

Before opening a geode, it is impossible to know exactly what, if anything, is inside. The only way to experience a geode's interior beauty is to open it up. This problematic step often results in crumbled geodes, damage to various tools, and dangerous airborne geode pieces. Much of a geode's beauty is lost when a whole geode crumbles. Geodes can be broken open using a diamond-bladed saw, hammer, hammer and chisel, or rock saw. Diamond-bladed saws are very expensive and dangerous for everyday use. A pipe cutter can be used to press a rolling carbon blade against a rock to cleanly cut it. Success with pipe cutters and geodes, however, is not guaranteed with every cut.

Generally, a whole geode, or any other type of rock, stone, or geological formation, can be cut into two half-spheres, multiple slices, or other shapes to reveal the crystals inside. A whole geode can be cleaned using a brush, chisel, and/or chemical and water wash to remove loose debris from the exterior surface of the geode. A whole geode can be broken or cut into at least two viable pieces, or grooved with a circumferential groove. A support layer can be added for additional strength, support, and geode crumbling prevention. The geode's interior crystals or concentric lines can be safely appreciated within a piece or section of a reassembled and re-broken geode. The geode can be cut into any number of shapes, two hemispheres or half-spheres, or sliced sections using a variety of cutting tools and methods.

In one embodiment, the geode lamp device comprises a base component that is configured in a rectangular, square, or oval shape or any other suitable shape as is known in the art. Generally, the base component can be any suitable size and shape as is known in the art, as long as the base component is of suitable size and shape to hold a geode or other crystal on it.

In one embodiment, the base component comprises a geode of varying sizes and shapes secured thereto. Generally, the geode is secured to the base component via any suitable securing means as is known in the art, such as bolts, screws, adhesives, gluing, etc. The geode can be any suitable shape and size as is known in the art. For example, the geode can be configured in the shape of a circle, square, or oval. Additionally, the geode can be made of different hues and colors. Further, depending on what crystals or geodes are used, each geode offers different healing properties. For example, amethyst offers calming, citrine offers joy, and quartz offers enhancing and clearing energy, etc.

In one embodiment, the base component comprises a plurality of LED lights secured around the geode or crystal. Any suitable number of LED lights can be utilized as is known in the art, depending on the needs and/or wants of a user. Further, the LED lights are secured to the geode and around the geode via any suitable securing means as is known in the art, such as gluing, adhesives, screws, etc. The plurality of LED lights act to illuminate the geode.

In one embodiment, the plurality of LED lights are in communication with a power button and/or a dimmer switch. Generally, the LED lights are controlled via the power button. Thus, the LED lights would be activated via the power button, and once turned on, the LED lights shine light at such an angle that the light shines in the direction of the geode, illuminating the geode from all angles. A user merely pushes the power button on or off, to control the LED lights as needed. Additionally, the user can also push the dimmer switch to raise and lower the intensity of the LED lights, as needed.

In one embodiment, the LED lights are powered via rechargeable batteries, an electrical cord, or other suitable power means as is known in the art. Further, the device also comprises a USB slot to accommodate several different electrical socket types for powering the lamp device. Further, multiple USB slots can be utilized to allow the lamp device to function with a wide variety of socket types for charging and powering the device.

In this embodiment, the plurality of LED lights emit light together and utilize a plurality of refractors and reflectors (i.e., optics) to allow the light sources to relatively disperse, causing the light intensity of a single LED light to be lower and softer, so that no glare is generated.

In one embodiment, the geodes are a neutral color and the plurality of LED lights can change colors, thus illuminating the geode in different colors and hues, depending on the needs and/or wants of a user.

In one embodiment, the base component is manufactured of wood, metal, or a polymer, such as polypropylene or acrylonitrile-butadiene-styrene (ABS), acrylic, polycarbonate, polyethylene terephthalate, polyvinyl chloride, polystyrene, etc. Generally, the base component is also manufactured from a material that is water resistant or waterproof, or the base component comprises a coating that is water resistant or waterproof. Furthermore, the base component can be molded in various colors and patterns to match existing decor, based on a user's preferences.

In yet another embodiment, the geode lamp device comprises a plurality of indicia.

In yet another embodiment, a method of illuminating a geode in a visually pleasing way is disclosed. The method includes the steps of providing a geode lamp device comprising a base component with a plurality of LED lights and a geode. The method also comprises choosing a geode of a specific size and configuration. Further, the method comprises securing the geode to the base component. The method also comprises illuminating the geode with a plurality of LED lights. Finally, the method comprises dimming or altering the hue of the geode based on a user's needs and/or wants.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the geode lamp device of the present invention showing the device applied to a circular geode in accordance with the disclosed architecture;

FIG. 2 illustrates a front perspective view of one embodiment of the geode lamp device of the present invention showing the device with a different color hue geode in accordance with the disclosed architecture;

FIG. 3 illustrates a perspective view of one embodiment of the geode lamp device of the present invention showing the device applied to an oval geode in accordance with the disclosed architecture;

FIG. 4 illustrates a front perspective view of one embodiment of the geode lamp device of the present invention showing the device with a different color hue geode in accordance with the disclosed architecture;

FIG. 5 illustrates a front perspective view of one embodiment of the geode lamp device of the present invention in use with an oval geode in accordance with the disclosed architecture; and

FIG. 6 illustrates a flowchart showing the method of illuminating a geode in a visually pleasing way in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a geode lamp device that provides users with an improved geode and crystal lamp with several LED lights to illuminate the crystals. There is also a long-felt need in the art for a geode lamp device that releases enhanced healing energy through the lamp to improve homeopathic self-healing. Further, there is a long-felt need in the art for a geode lamp device that includes a USB slot to accommodate several different socket types for powering the lamp. Moreover, there is a long-felt need in the art for a device that functions as a convenient night light and lamp with a unique and decorative aesthetic. Further, there is a long-felt need in the art for a geode lamp device that is designed to illuminate geodes in a visually pleasing way. Finally, there is a long-felt need in the art for a geode lamp device that can be used with any suitable shape and size of geode.

The present invention, in one exemplary embodiment, is a novel geode lamp device. The device is a modified lamp designed to illuminate geodes in a visually pleasing way. The lamp device comprises a wooden base component with a plurality of LED lights secured to it. Geodes are then secured to the wooden base component to be illuminated by the LED lights. The lamp device comprises three different color options for hue. Further, the device is dimmable depending on the needs and/or wants of a user. The lamp device is also USB compatible to allow the lamp device to function with a wide variety of socket types. Additionally, the geodes can be configured in square, oval, or circular shapes. The present invention also includes a novel method of illuminating a geode in a visually pleasing way. The method includes the steps of providing a geode lamp device comprising a base component with a plurality of LED lights and a geode. The method also comprises choosing a geode of a specific size and configuration. Further, the method comprises securing the geode to the base component. The method also comprises illuminating the geode with a plurality of LED lights. Finally, the method comprises dimming or altering the hue of the geode based on a user's needs and/or wants.

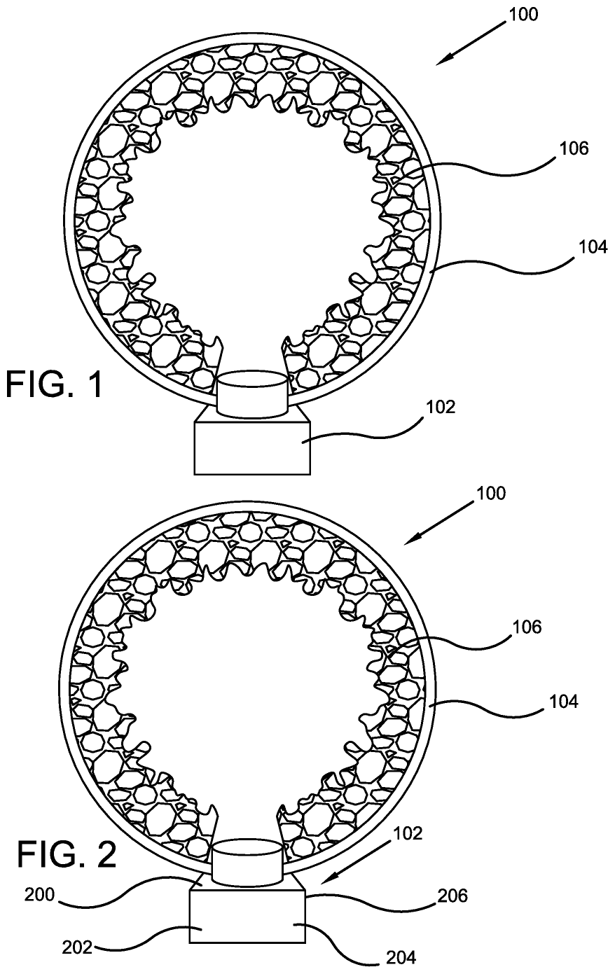

Referring initially to the drawings, FIG. 1 illustrates a perspective view of one embodiment of the geode lamp device 100 of the present invention. In the present embodiment, the geode lamp device 100 is an improved geode lamp device 100 that provides a user with a modified lamp designed to illuminate geodes in a visually pleasing way. Specifically, the geode lamp device 100 comprises a base component 102 with a plurality of LED lights 104 secured to it. Geodes 106 are then secured to the base component 102 to be illuminated by the LED lights 104. The lamp device 100 comprises three different main color options for hue. Further, the device 100 is dimmable depending on the needs and/or wants of a user. The lamp device 100 is also USB compatible to allow the lamp device 100 to function with a wide variety of electrical socket types.

Overall, a geode 106 is typically a spherical, geological rock formation with an interior core space containing an inner lining of crystals projecting inward or layers of concentric banding. Geodes 106 are essentially rock cavities or “vugs” with internal crystal formations or concentric banding. The plain geode exterior is generally limestone or a related rock that often reveals nothing of the beautiful, intricate display of interior crystals or banding. Other geodes 106 are completely filled with crystal or solid throughout. These types of solid geodes are called nodules. Geodes 106 can be found all over the world and are most commonly located in deserts, volcanic ash beds, or regions containing limestone. Further, geodes 106 are commonly found in California, Utah, Arizona, and numerous locations in Mexico, Brazil, and Namibia.

Generally, geodes 106 can be cut open to reveal the crystals in the core of the geode 106. Quartz is the most common mineral forming crystals within geodes 106. Still, geode cores contain agate, chalcedony, or jasper banding or crystals such as calcite, dolomite, celestite, etc. The color of the crystals depends on the type of contaminant that entered the geode 106 when it was forming. Samples of geodes 106 with unusual colors or highly unlikely formations are either synthetically dyed or altered with artificial colorants or pigments.

Before opening a geode 106, it is impossible to know exactly what, if anything, is inside. The only way to experience a geode's interior beauty is to open it up. This problematic step often results in crumbled geodes, damage to various tools, and dangerous airborne geode pieces. Much of a geode's beauty is lost when a whole geode crumbles. Geodes 106 can be broken open using a diamond-bladed saw, hammer, hammer and chisel, or rock saw. Diamond-bladed saws are very expensive and dangerous for everyday use. A pipe cutter can be used to press a rolling carbon blade against a rock to cleanly cut it. There is some success with pipe cutters and geodes 106, however, it is not guaranteed with every cut.

Generally, a whole geode 106, or any other type of rock, stone, or geological formation, can be cut into two half-spheres, multiple slices, or other shapes to reveal the crystals inside. A whole geode 106 can be cleaned using a brush, chisel, and/or chemical and water wash to remove loose debris from the exterior surface of the geode 106. A whole geode 106 can be broken or cut into at least two viable pieces, or grooved with a circumferential groove. A support layer can be added for additional strength, support, and geode crumbling prevention. The geode's interior crystals or concentric lines can be safely appreciated within a piece or section of a reassembled and re-broken geode. The geode 106 can be cut into any number of shapes, two hemispheres or half-spheres, or sliced sections using a variety of cutting tools and methods.

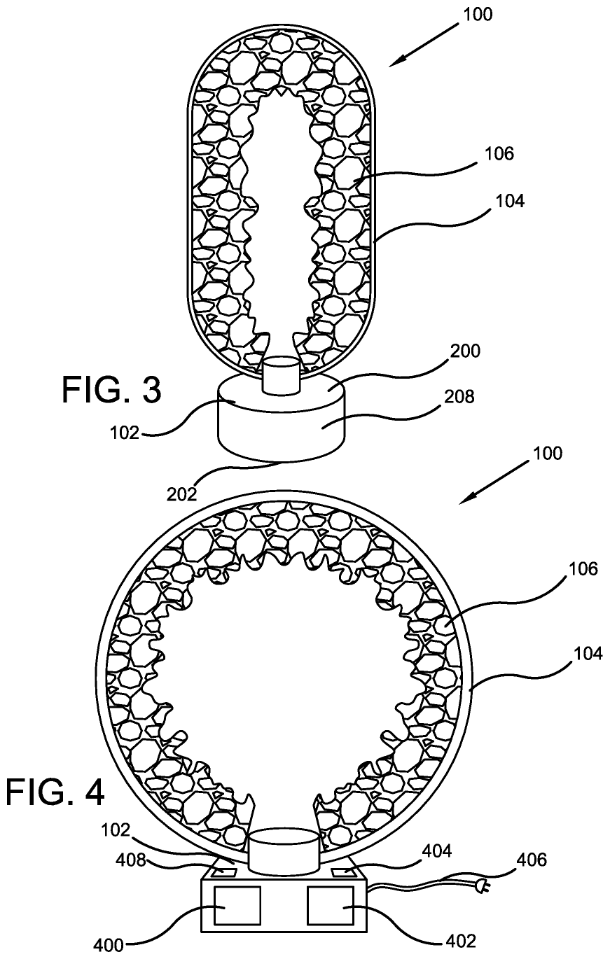

As shown in FIGS. 2-3, the geode lamp device 100 comprises a base component 102 that is configured in a rectangular, square, or oval shape or any other suitable shape as is known in the art. Generally, the base component 102 can be any suitable size and shape as is known in the art, as long as the base component 102 is of suitable size and shape to hold a geode 106 or other crystal on it. Further, the base component 102 in a rectangular or square configuration comprises a top surface 200, a bottom surface 202, opposing front and back sides 204, and opposing left and right sides 206. If the base component 102 is in a circular configuration, then the base component 102 comprises a top surface 200, a bottom surface 202, and a sidewall 208.

Generally, the base component 102 also comprises a geode 106 of varying sizes and shapes secured thereto. Generally, the geode 106 is secured to the base component 102 via any suitable securing means as is known in the art, such as bolts, screws, adhesives, gluing, etc. The geode 106 can be any suitable shape and size as is known in the art. For example, the geode 106 can be configured in the shape of a circle, square, or oval. Additionally, the geode 106 can be made of different hues and colors, depending on the needs and/or wants of a user. Further, depending on what crystals or geodes 106 are used, each geode 106 offers different healing properties. For example, amethyst offers calming, citrine offers joy, and quartz offers enhancing and clearing energy, etc.

As shown in FIG. 4, the base component 102 comprises a plurality of LED lights 104 secured around the geode 106 or crystal. Any suitable number of LED lights 104 can be utilized as is known in the art, depending on the needs and/or wants of a user. Further, the LED lights 104 are secured to the geode 106 and around the geode 106 via any suitable securing means as is known in the art, such as gluing, adhesives, screws, etc. The plurality of LED lights 104 act to illuminate the geode 106.

Furthermore, the plurality of LED lights 104 are in communication with a power button 400 and/or a dimmer switch 402. Generally, the LED lights 104 are controlled via the power button 400. Thus, the LED lights 104 would be activated via the power button 400, and once turned on, the LED lights 104 shine light at such an angle that the light shines in the direction of the geode 106, illuminating the geode 106 from all angles. A user merely pushes the power button 400 on or off, to control the LED lights 104 as needed. Additionally, the user can also push the dimmer switch 402 to raise and lower the intensity of the LED lights 104, as needed.

In one embodiment, the LED lights 104 are powered via rechargeable batteries 404, an electrical cord 406, or other suitable power means as is known in the art. Further, the device 100 also comprises a USB slot 408 to accommodate several different electrical socket types for powering the lamp device 100. Further, multiple USB slots 408 can be utilized to allow the lamp device 100 to function with a wide variety of socket types for charging and powering the device 100.

Generally, the plurality of LED lights 104 emit light together and utilize a plurality of refractors and reflectors (i.e., optics) to allow the light sources to relatively disperse, causing the light intensity of a single LED light 104 to be lower and softer, so that no glare is generated.

In one embodiment, the geodes 106 are a neutral color and the plurality of LED lights 104 can change colors, thus illuminating the geode 106 in different colors and hues, depending on the needs and/or wants of a user.

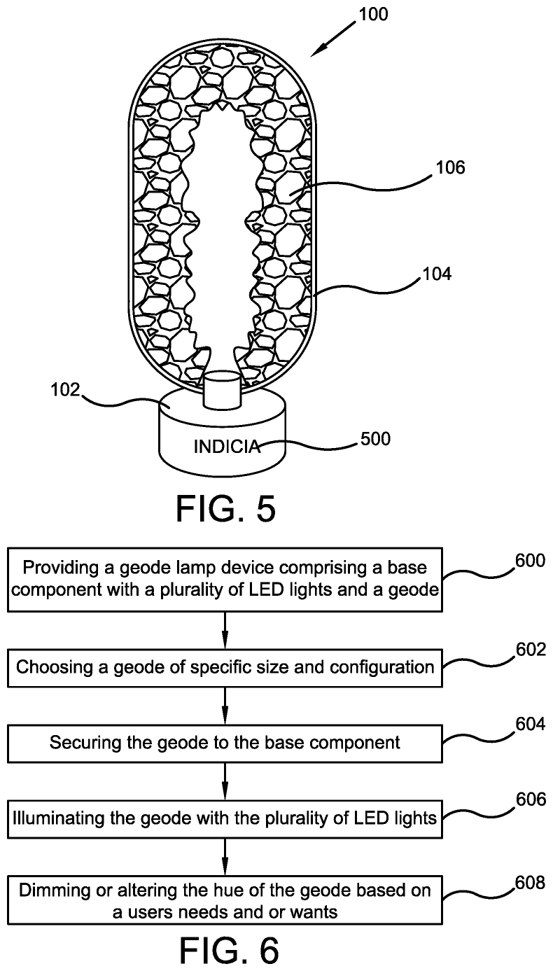

As shown in FIG. 5, the base component 102 is manufactured of wood, metal, or a polymer, such as polypropylene, acrylonitrile-butadiene-styrene (ABS), acrylic, polycarbonate, polyethylene terephthalate, polyvinyl chloride, polystyrene, etc. Generally, the base component 102 is also manufactured from a material that is water resistant or waterproof, or the base component 102 comprises a coating that is water resistant or waterproof. Furthermore, the base component 102 can be molded in various colors and patterns to match existing decor, based on a user's preferences.

In yet another embodiment, the geode lamp device 100 comprises a plurality of indicia 500. The base component 102 of the device 100 may include advertising, a trademark, or other letters, designs, or characters, printed, painted, stamped, or integrated into the base component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be geode, LEDs, or brand related.

FIG. 6 illustrates a flowchart of the method of illuminating a geode in a visually pleasing way. The method includes the steps of at 600, providing a geode lamp device comprising a base component with a plurality of LED lights and a geode. The method also comprises at 602, choosing a geode of specific size and configuration. Further, the method comprises at 604, securing the geode to the base component. The method also comprises at 606, illuminating the geode with the plurality of LED lights. Finally, the method comprises at 608, dimming or altering the hue of the geode based on a user's needs and/or wants.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “geode lamp device”, “geode device”, “lamp device”, and “device” are interchangeable and refer to the geode lamp device 100 of the present invention.

Notwithstanding the foregoing, the geode lamp device 100 of the present invention can be of any suitable size and configuration as is known in the art without affecting the overall concept of the invention, provided that it accomplishes the above-stated objectives. One of ordinary skill in the art will appreciate that the geode lamp device 100 as shown in FIGS. 1-6 is for illustrative purposes only, and that many other sizes and shapes of the geode lamp device 100 are well within the scope of the present disclosure. Although the dimensions of the geode lamp device 100 are important design parameters for user convenience, the geode lamp device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A geode lamp device that provides a user with a modified lamp to illuminated geodes, the geode lamp device comprising:
a base component;
a light component; and
a geode;
wherein the geode is secured to the base component; and
further wherein the light component is secured to the geode to illuminate the geode.

2. The geode lamp device of claim 1, wherein the base component is configured in a rectangular, square, or oval shape.

3. The geode lamp device of claim 2, wherein the base component comprises a top surface, a bottom surface, opposing front and back sides, and opposing left and right sides.

4. The geode lamp device of claim 3, wherein the geode can be configured in the shape of a circle, square, or an oval.

5. The geode lamp device of claim 4, wherein the geode is made of different hues and colors.

6. The geode lamp device of claim 5, wherein each geode offers different healing properties, such as, amethyst offers calming, citrine offers joy, and quartz offers enhancing and clearing energy.

7. The geode lamp device of claim 6, wherein the light component is a plurality of LED lights.

8. The geode lamp device of claim 7, wherein the plurality of LED lights are secured to the geode and around the geode.

9. The geode lamp device of claim 8, wherein the plurality of LED lights are in communication with a power button to turn on and off the plurality of LED lights.

10. The geode lamp device of claim 9, wherein the plurality of LED lights are in communication with a dimmer switch, which raises and lowers intensity of the plurality of LED lights.

11. The geode lamp device of claim 10, wherein the plurality of LED lights are powered via rechargeable batteries or an electrical cord.

12. The geode lamp device of claim 11, wherein the base component comprises at least one USB slot to accommodate an electrical cord.

13. The geode lamp device of claim 12, wherein the geode is a neutral color and the plurality of LED lights change colors, illuminating the geode in different colors and hues.

14. A geode lamp device that provides a user with a modified lamp to illuminated geodes, the geode lamp device comprising:
a base component configured in a rectangular shape, comprising a top surface, a bottom surface, opposing front and back sides, and opposing left and right sides;
a plurality of LED lights; and
a geode configured in shape of a circle, square, or oval and made of different hues and colors;
wherein the geode is secured to the base component;
wherein each geode offers different healing properties, such as, amethyst offers calming, citrine offers joy, and quartz offers enhancing and clearing energy; and
wherein the light component is secured to the geode to illuminate the geode;
wherein the plurality of LED lights are in communication with a power button to turn on and off the plurality of LED lights;
wherein the plurality of LED lights are in communication with a dimmer switch, which raises and lowers intensity of the plurality of LED lights;
wherein the plurality of LED lights are powered via rechargeable batteries or an electrical cord; and
further wherein the base component comprises at least one USB slot to accommodate an electrical cord.

15. The geode lamp device of claim 14, wherein the base component is manufactured from a material that is water resistant or waterproof, or the base component comprises a coating that is water resistant or waterproof.

16. The geode lamp device of claim 14, wherein the base component is molded in various colors and patterns to match existing decor.

17. The geode lamp device of claim 14 further comprising a plurality of indicia.

18. The geode lamp device of claim 14, wherein the geode is a neutral color and the plurality of LED lights change colors, illuminating the geode in different colors and hues.

19. The geode lamp device of claim 14, wherein the geode lamp device functions as a nightlight.

20. A method of illuminating a geode in a visually pleasing way, the method comprising the following steps:
providing a geode lamp device comprising a base component with a plurality of LED lights and a geode;
choosing a geode of specific size and configuration;
securing the geode to the base component;
illuminating the geode with the plurality of LED lights; and
dimming or altering the hue of the geode based on a user's needs and/or wants.
